(19) United States
(12) Patent Application Publication
(10) Pub. No.: US 2026/0222814 A1
(43) Pub. Date: Jul. 30, 2026

(54) Authorization of Notification Providers

(71) Applicant: Telefonaktiebolaget LM Ericsson (publ), Stockholm (SE)

(72) Inventors: Jesus Angel De Gregorio Rodriguez, Madrid (ES); Sune Gustafsson, Öxabäck (SE); Cheng Wang, Shanghai (CN); Songmao Li, Shanghai (CN); Christine Jost, Dalby (SE); Bernard Smeets, Dalby (SE)

(21) Appl. No.: 19/144,686

(22) PCT Filed: Feb. 2, 2024
(86) PCT No.: PCT/EP2024/052566

§ 371 Date: Jun. 30, 2025

(30) Foreign Application Priority Data
Feb. 13, 2023 (WO) PCT/CN2023/075629

(51) Int. Cl. H04W 12/08; H04W 12/0431; H04W 12/06; H04W 12/106

(52) U.S. Cl. CPC H04W 12/08; H04W 12/0431; H04W 12/06; H04W 12/106

(57) ABSTRACT

Embodiments include methods performed by a receiver network function (NF) arranged to receive notifications from notifier NFs of a communication network. Such methods include generating a first access token indicating that a notifier NF is authorized to send notifications to the receiver NF in accordance with a subscription and sending to a first NF of the communication network a first message related to a subscription for receiving notifications from the notifier NF. The first message includes the first access token. Such methods include receiving a notification from the notifier NF in accordance with the subscription. The notification includes or is received in association with a further access token. Such methods include, based on the further access token, verifying that the notifier NF is authorized to send the notification. Other embodiments include complementary methods performed by notifier NFs, subscriber NFs, and network repository functions as well as network nodes/functions that perform such methods.

### TECHNICAL FIELD

The present application relates generally to the field of communication networks, and more specifically to techniques for ensuring that notifications of available data are only sent by network functions (NFs) in a communication network that are authorized to provide such notifications.

### INTRODUCTION

Currently the fifth generation (5G) of cellular systems is being standardized within the Third-Generation Partnership Project (3GPP). 5G is developed for maximum flexibility to support many different use cases including enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides user equipment (UEs) with connectivity to the CN, e.g., via base stations such as gNBs or ng-eNBs described below. The CN includes a variety of Network Functions (NFs) that provide a wide range of different functionalities such as session management, connection management, charging, authentication, etc.

A UE communicates with the CN over the Non-Access Stratum (NAS), and with the AN over the Access Stratum (AS). All NAS communication takes place between a UE and an access and mobility m AMF via the NAS protocol. Security for the communications over this these strata is provided by the NAS protocol and packet data convergence protocol (PDCP) for AS.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, each gNB-DU can be connected to only one gNB-CU. The gNB-CU and its connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

3GPP TS 33.501 (v17.8.0) describes security architecture and procedures for the 5G system, including the SBA. One security technique used in the SBA is token-based authorization. For example, 3GPP TS 33.501 section 13.4.1 discusses authorization of access to NF services using the OAuth 2.0 framework described in IETF RFC 6749 based on access tokens secured by digital signatures.

3GPP TR 33.875 (v1.6.0) describes a “Study on enhanced security aspects of the 5G Service Based Architecture (SBA)”. One issue (called “Key Issue #3”) addressed by this study is service access in “Subscribe/Notify” scenarios, particularly the risk that a service producer NF (NFp) may send a notification message to an unauthorized service consumer NF (NFc). There are some proposals to authorize a notification uniform resource identifier (URI) by the NRF and provide an access token with the authorized notification URI to the NFc, which can use it when subscribing for notifications.

### SUMMARY

Even if an NFc is authorized to receive notifications for a subscription, it is unclear how the NFc can be sure that a notification is from a notifier NF (e.g., NFp) that is authorized to send notifications to the NFc. For example, a notification URI can be obtained by an unauthorized third party, who could use it to send false notifications to provoke NFc actions with undesirable consequences.

Embodiments of the present disclosure address these and other problems, issues, and/or difficulties, thereby enabling the otherwise-advantageous deployment of SBA in a 5G system.

Some embodiments of the present disclosure include methods (e.g., procedures) for a receiver network function (NF) arranged to receive notifications from notifier NFs of a communication network (e.g., 5GC).

These exemplary methods include generating a first access token indicating that a notifier NF is authorized to send notifications to the receiver NF in accordance with a subscription. These exemplary methods also include sending, to a first NF of the communication network, a first message related to a subscription for receiving notifications from a notifier NF of the communication network. The first message includes the first access token. These exemplary methods also include receiving a notification from the notifier NF in accordance with the subscription. The notification includes or is received in association with a further access token. These exemplary methods also include, based on the further access token, verifying that the notifier NF is authorized to send the notification.

In some embodiments, the first NF is the notifier NF and the first message is a subscription request for notifications from the notifier NF. In other embodiments, the first NF is a subscriber NF different from the receiver NF and the first message is one of the following: a subscription request for notifications from the notifier NF, or a service request indicating that the subscriber NF should subscribe to notifications on behalf of the receiver NF.

In other embodiments, these exemplary methods also include registering the receiver NF's NF profile with an NRF of the communication network. The registered NF profile includes a default callback uniform resource identifier (URI), at which the receiver NF can receive notifications, and one of the following:
a token endpoint, from which access tokens for sending notifications to the receiver NF can be obtained; or
a default access token for sending notifications to the receiver NF.

In some of these embodiments, these exemplary methods can also include receiving a token request from the notifier NF via the token endpoint. The first access token is generated in response to the token request, the first message is a token response, and the notification is received at the default callback URI.

In some embodiments, the first access token includes one or more of the following information:
an indication of whether the subscription is implicit or explicit;
an identifier of the subscription;
a validity duration associated with the subscription;
a notification type associated with the subscription;
a callback URI at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances; and
one or more of the following associated with the notifier NF: NF type, NF set, and one or more NF instances.

In some embodiments, the first message includes one or more of the following information:
an indication of whether the subscription is implicit or explicit;
an identifier of the subscription;
a validity duration associated with the subscription;
a notification type associated with the subscription;
a callback URI at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances;
one or more of the following associated with the notifier NF: NF type, NF set, and one or more NF instances; and
a URI from which a public key of the receiver NF can be obtained.

In some embodiments, verifying that the notifier NF is authorized to send the notification includes storing the generated first access token and comparing the stored first access token to the received further access token. In such case, a match or correspondence between the first access token and the further access token indicates that the notifier NF is authorized to send the notification.

In other embodiments, generating the first access token includes applying integrity protection to the first access token using a private key of the receiver NF. Also, verifying that the notifier NF is authorized to send the notification includes verifying corresponding integrity protection included in or with the further access token based on a public key of the receiver NF.

In some of these embodiments, the integrity protection applied to the first access token comprises one of the following generated using the private key: digital signature, message authentication code, and cryptographic hash. In some of these embodiments, the public key and the private key are locally generated by the receiver NF. In some of these embodiments, verifying the corresponding integrity protection included in or with the further access token includes determining that the further access token was generated by the receiver NF, has not been modified by another entity, and has an unexpired validity duration.

In some embodiments, the first message includes a second access token indicating that the receiver NF is authorized to subscribe to the notifications from the notifier NF. In some embodiments, the receiver NF is an AMF and/or the notifier NF is a UDM function.

Other embodiments include exemplary methods (e.g., procedures) for a notifier NF arranged to send notifications to receiver NFs in a communication network (e.g., 5GC).

These exemplary methods include receiving, from a first NF of the communication network, a first message related to a subscription for a receiver NF to receive notifications from the notifier NF. The first message includes a first access token indicating that the notifier NF is authorized to send notifications to the receiver NF in accordance with the subscription These exemplary methods also include sending to the receiver NF a notification in accordance with the subscription request. The notification includes or is sent in association with the first access token.

In some embodiments, the first message is a subscription request for notifications from the notifier NF and the first NF is the receiver NF or a subscriber NF authorized to subscribe to notifications on behalf of the receiver NF. In some of these embodiments, the subscription request is for the receiver NF to receive notifications from the notifier NF. In other of these embodiments, the subscription request is for the receiver NF and the subscriber NF to receive notifications from the notifier NF, and the first message includes a further first access token indicating that the notifier NF is authorized to send notifications to the subscriber NF in accordance with the subscription.

In other embodiments, the first NF is the notifier NF and the first message is a token response. In some of these embodiments, these exemplary methods can also include obtaining the following from an NRF of the communication network:
a default callback URI, at which the receiver NF can receive notifications; and
a token endpoint, from which access tokens for sending notifications to the receiver NF can be obtained.

These exemplary methods also include sending a token request to the receiver NF via the token endpoint. In such case, the token response is responsive to the token request and the notification is sent to the default callback URI.

In various embodiments, the first access token can include any of the information summarized above in relation to receiver NF embodiments. In various embodiments, the first message can include any of the information summarized above in relation to receiver NF embodiments.

In some embodiments, the first access token is integrity protected based on a private key of the receiver NF and these exemplary methods can also include verifying the integrity protection of the first access token based on a public key of the receiver NF. In some of these embodiments, the integrity protection of the first access token comprises one of the following generated based on the private key of the receiver NF: digital signature, message authentication code, and cryptographic hash. In some of these embodiments, verifying the integrity protection of the first access token includes determining that the first access token was generated by the receiver NF, has not been modified by another entity, and has an unexpired validity duration.

In some embodiments, the first message includes a second access token indicating that the receiver NF is authorized to subscribe to the notifications from the notifier NF. In some embodiments, the receiver NF is an AMF and/or the notifier NF is a UDM function.

Other embodiments include methods (e.g., procedures) for a subscriber NF arranged to subscribe to notifications from a notifier NF of a communication network on behalf of a receiver NF of the communication network (e.g., 5GC).

These exemplary methods include receiving, from the receiver NF, a first message related to a subscription for receiving notifications from the notifier NF. The first message includes a first access token indicating that the notifier NF is authorized to send notifications to the receiver NF in accordance with the subscription. These exemplary methods also include sending to the notifier NF a subscription request in accordance with the service request. The subscription request includes the first access token.

In some embodiments, the first message is a subscription request for notifications from the notifier NF. In some embodiments, the first message is a service request indicating that the subscriber NF should subscribe to notifications from the notifier NF on behalf of the receiver NF.

In some embodiments, these exemplary methods also include generating a second access token indicating that the notifier NF is authorized to send notifications to the subscriber NF in accordance with the subscription of the receiver NF. In such case, the subscription request to the notifier NF includes the second access token, as well as the first access token received from the receiver NF.

In some of these embodiments, these exemplary methods also include the following:
receiving a notification from the notifier NF in accordance with the subscription, wherein the notification includes or is received in association with a further access token; and
based on the further access token, verifying that the notifier NF is authorized to send the notification.

In some of these embodiments, verifying that the notifier NF is authorized to send the notification includes storing the generated second access token and comparing the stored second access token to the received further access token. In such case, a match or correspondence between the second access token and the further access token indicates that the notifier NF is authorized to send the notification.

In other embodiments, generating the second access token includes applying integrity protection to the second access token using a private key of the subscriber NF. Also, verifying that the notifier NF is authorized to send the notification includes verifying corresponding integrity protection included in or with the further access token based on a public key of the subscriber NF.

In some of these embodiments, the integrity protection applied to the second access token comprises one of the following generated using the private key of the subscriber NF: digital signature, message authentication code, and cryptographic hash. In some of these embodiments, the public key and the private key are locally generated by the subscriber NF. In some of these embodiments, verifying the corresponding integrity protection included in or with the further access token includes determining that the further access token was generated by the subscriber NF, has not been modified by another entity, and has an unexpired validity duration.

In various embodiments, the first access token can include any of the information summarized above in relation to receiver NF embodiments. In various embodiments, the first message can include any of the information summarized above in relation to receiver NF embodiments. In some embodiments, the subscription request includes at least a portion of the information included in the first message.

In some embodiments, one or more of the following applies: the receiver NF is a first AMF, the notifier NF is a UDM function, and the subscriber NF is a second AMF different from the first AMF.

Other embodiments include methods (e.g., procedures) for an NRF of a communication network. These exemplary methods include registering a NF profile of a receiver NF of the communication network. The registered NF profile includes a default callback URI, at which the receiver NF can receive notifications, and one of the following:
a token endpoint, from which access tokens for sending notifications to the receiver NF can be obtained; or
a default access token for sending notifications to the receiver NF.

These exemplary methods also include receiving, from a notifier NF of the communication network, a discovery request to identify NFs of the communication network that are subscribed to notifications provided by the notifier NF. These exemplary methods also include identify the receiver NF based on the registered NF profile and the discovery request, and sending to the notifier NF a discovery response that includes the default callback URI and the token endpoint. In some embodiments, the receiver NF is an AMF and/or the notifier NF is a UDM function.

Other embodiments include receiver NFs, notifier NFs, subscriber NFs, and NRFs (or network equipment implementing or hosting the same) that are configured to perform the operations corresponding to any of the exemplary methods described herein. Other embodiments also include non-transitory, computer-readable media storing computer-executable instructions that, when executed by processing circuitry associated with such receiver NFs, notifier NFs, subscriber NFs, and NRFs, configure the same to perform operations corresponding to any of the exemplary methods described herein.

These and other embodiments described herein can improve security in a communication network by an access token that indicates a producer NF that is authorized (e.g., by consumer NF) to provide notifications related to subscriptions. Information in the access token can be used by the consumer NF to ensure that it receives notifications only from authorized senders. This can improve security of the 5G SBA by mitigating various attack scenarios.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIGS. 3-5 illustrates various arrangements in which a service consumer NF subscribes to notifications from a service producer NF.

FIGS. 6A-B show various aspects of a procedure for a service consumer NF to obtain an access token for accessing services provided by a service producer NF.

FIG. 7 is a signaling diagram of a procedure for a service consumer NF to obtain an access token for subscribing to notifications from a service producer NF.

FIGS. 8-10 show signaling diagrams of various procedures for obtaining and using an access token for sending notifications, according to various embodiments of the present disclosure.

FIG. 11 shows an exemplary method (e.g., procedure) for a receiver NF of a communication network, according to various embodiments of the present disclosure.

FIG. 12 shows an exemplary method (e.g., procedure) for a notifier NF of a communication network, according to various embodiments of the present disclosure.

FIG. 13 shows an exemplary method (e.g., procedure) for a subscriber NF of a communication network, according to various embodiments of the present disclosure.

FIG. 14 shows an exemplary method (e.g., procedure) for an NRF of a communication network, according to various embodiments of the present disclosure.

FIG. 15 shows a communication system according to various embodiments of the present disclosure.

FIG. 16 shows a network node according to various embodiments of the present disclosure.

FIG. 17 is a block diagram of a virtualization environment in which functions implemented by some embodiments of the present disclosure may be virtualized.

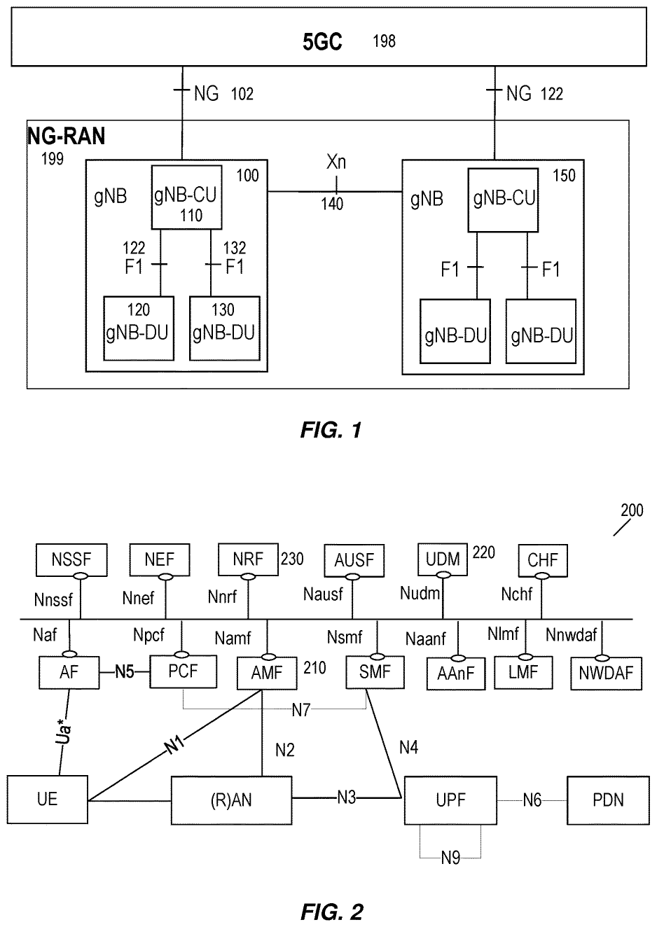

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

FIG. 2 shows an exemplary non-roaming reference architecture for a 5G network (200). These include the following 3GPP-defined NFs and service-based interfaces:
Application Function (AF, with Naf interface)—interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface)—supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface)—interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface)—responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, 210, with Namf interface)—terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF, with Nnef interface)—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF, 230, with Nnrf interface)—provides service registration and discovery, enabling NFs to identify appropriate services available from other NFs.
Network Slice Selection Function (NSSF, with Nnssf interface)—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice.

The NSSF enables other NFs (e.g., AMF) to identify a network slice instance that is appropriate for a UE's desired service.
Authentication Server Function (AUSF, with Nausf interface)—based in a user's home network (HPLMN), it performs user authentication and computes security key materials for various purposes.
Network Data Analytics Function (NWDAF, with Nnwdaf interface)—provides network analytics information (e.g., statistical information of past events and/or predictive information) to other NFs on a network slice instance level.
Location Management Function (LMF, with Nlmf interface)—supports various functions related to determination of UE locations, including location determination for a UE and obtaining any of the following: DL location measurements or a location estimate from the UE; UL location measurements from the NG RAN; and non-UE associated assistance data from the NG RAN.

Unified Data Management (UDM) function (220) supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF. Data Storage Functions (DSF) allow NFs to store context.

The 5G SBA model is based on principles including modularity, reusability and self-containment of NFs, which can enable network deployments to take advantage of the latest virtualization and software technologies. The services provided by the various NFs are composed of “service operations”, which are more granular divisions of the overall service functionality. The interactions between service consumers and producers can be of the type “request/response” or “subscribe/notify”. In the latter type, a service consumer NF (or equivalently, “service consumer NF”) requests a service producer NF (or equivalently, “service producer NF”) to establish a subscription for the service consumer NF to receive notifications from the service producer NF under conditions specified in this subscription.

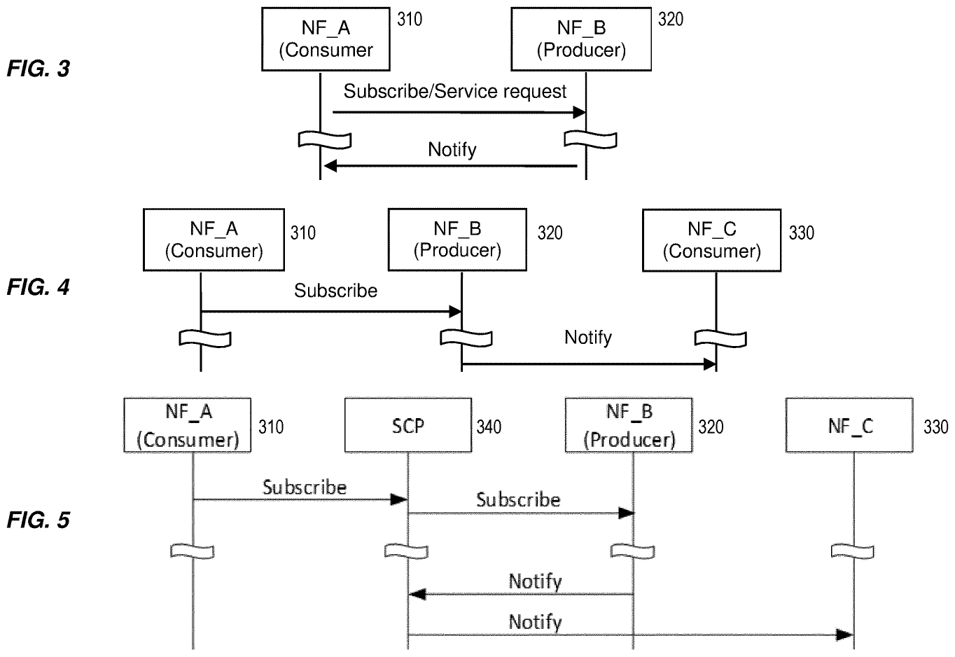

FIG. 3 shows an exemplary “Subscribe/Notify” arrangement in which a service consumer NF (e.g., NF_A 310) subscribes to notifications from a service producer NF (e.g., NF_B 320), either explicitly or implicitly. The subscription or service request includes the notification endpoint (e.g., notification URL) of the service consumer NF. In this scenario, NF A subscribes to the service of NF B for itself.

FIG. 4 shows another exemplary “Subscribe/Notify” arrangement in which one service consumer NF (e.g., NF_A 310) subscribes to notifications from a service producer NF (e.g., NF_B 320), either explicitly or implicitly, on behalf of another service consumer NF (e.g., NF_C 330). The notification URI of NR_C is included in the subscription request, and NF_C will receive the notification message even though the subscribe request is sent by NF_A.

FIG. 5 shows another exemplary “Subscribe/Notify” arrangement whereby a service consumer NF (e.g., NF_A 310) uses a service communication proxy (SCP, 340) for indirect communication with the service producer NF (e.g., NF_B 320). The SCP routes messages between service consumer NFs and service producer NFs based on the Routing Binding Indication (if available) and may perform discovery and associated selection of the service producer NF on behalf of a service consumer NF. In FIG. 5, the SCP forwards the subscription request to NF_B but since the subscription is on behalf of NF_C (330), the SCP forwards notifications from NF B to NF C.

3GPP TS 33.501 (v17.8.0) describes security architecture and procedures for the 5G system, including the SBA. One security technique used in the SBA is token-based authorization. For example, 3GPP TS 33.501 section 13.4.1 discusses authorization of access to NF services using the OAuth 2.0 framework described in IETF RFC 6749 based on access tokens secured by digital signatures. In particular, a service consumer NF (NFc) acts as an OAuth 2.0 client, the service producer NF (NFp) acts as an OAuth 2.0 resource server, and the NRF acts as an OAuth 2.0 authorization server.

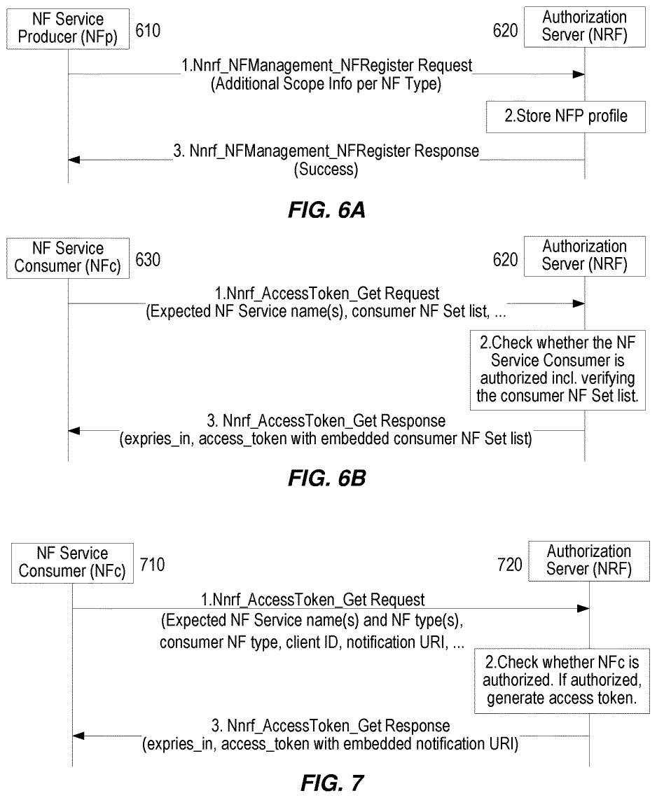

FIG. 6A is a flow diagram of an exemplary procedure for a service producer NF (NFp, 610) to register as an OAuth 2.0 resource server with NRF (620). In operation 1, the NFp invokes an Nnrf_NFManagement_NFRegister Request service operation to provide its NF profile for registration in NRF. The NF profile configuration data of the NFp may include “additional scope” information that indicates NFp resources and service operations that are allowed for an NFc. These resources may be per NF type or per NF instance ID of the NFc. In operations 2-3, the NRF stores the NF profile provided by the NFp and responds with an Nnrf_NFManagement_NFRegister Response service operation indicating successful registration.

FIG. 6B is a flow diagram of an exemplary procedure for a service consumer NF (NFc, 630) to obtain an access token for accessing services provided by a service producer NF (NFp, e.g., 610 in FIG. 6A). For example, the procedure shown in FIG. 6B may be based on successful completion of the procedure shown in FIG. 6A.

In operation 1, the NFc requests an access token from the NRF in the same public land mobile network (PLMN) using the Nnrf_AccessToken_Get request operation. The request message includes the NF Instance ID(s) of the service consumer NF, the requested “scope” including the expected NF Service name(s). The message may include “additional scope” information such as requested resources, requested actions (e.g., service operations) on the resources, and NF type(s) of the expected NFp instance and the NFc.

The NFc may also include a list of NSSAIs or list of NSI IDs for the expected NFp instances. NSSAI is a group of one or more single network slice selection assistance information (S-NSSAI), each of which includes a slice type (SST) field that describes expected network behavior and optionally a slice differentiator (SD) field that provides further behavior differentiation. In some cases, the NFc may also include a list of S-NSSAIs of the service consumer NF. In some cases, the NFc may also include the NF Set ID of the expected NFp instances.

The requested service or service operation can be a “subscription request”, e.g., an explicit subscription or any other kind of service invocation that can be interpreted as an implicit subscription. In the embodiments illustrated by FIG. 6B, the message includes a consumer NF Set list for the expected alternative notification receivers.

In operation 2, the NRF verifies that the input parameters (e.g., NF type, consumer NF Set list) in the access token request match with the corresponding ones in the public key certificate of the NFc or with those in the NF profile of the NFc. The NRF checks whether the NFc is authorized to access the requested service(s). If the NFc is authorized, the NRF generates an access token with appropriate AccessTokenClaims included. The NRF digitally signs the generated access token based on a shared secret or private key as described in RFC 7515 published by the IETF. If the NFc is not authorized, the NRF does not issue an access token to the NFc.

The AccessTokenClaims in the token include the NF Instance ID of NRF (issuer), NF Instance ID of the NFc (subject), NF type of the NFp (audience), expected service name(s), (scope), expiration time (expiration) and optionally “additional scope” information such as allowed resources and allowed actions (service operations) on the resources. The AccessTokenClaims may include a list of NSSAIs or NSI IDs for the expected service producer NF instances, and/or the NF Set ID of the expected service producer NF instances.

If the authorization is successful in operation 2, in operation 3 the NRF sends the access token with the above information to the service consumer NF using Nnrf_AccessToken_GetResponse. The other parameters (e.g., expiration time, allowed scope) sent by NRF in addition to the access token are described in 3GPP TS 29.510. If the authorization is unsuccessful in operation 2, the NRF replies in operation 3 based on OAuth 2.0 error response defined in IETF RFC 6749.

The NFc can then send the received access token to the NFp in a service request. The NFp verifies the integrity and claims in the access token and, if successful, executes the requested service for the NFc and generates a service response to the NFc.

3GPP TR 33.875 (v1.6.0) describes a “Study on enhanced security aspects of the 5G Service Based Architecture (SBA)”. One issue (called “Key Issue #3”) addressed by this study is service access in “Subscribe/Notify” scenarios (e.g., as shown in FIGS. 3-5 above), particularly the risk that an NFp may send a notification (or notify) message to an unauthorized NFc if the notification uniform resource identifier (URI) in the subscribe request is not authorized.

The service consumer NF can use binding to indicate suitable service consumer NF instance(s) for notification target instance selection, reselection and routing of subsequent notification requests associated with a specific notification subscription. Binding indication needs to be stored by the service producer NF and may also be used later if the service consumer NF starts acting as service producer NF, so that service requests can be sent to this service producer NF.

Similarly, binding can be used to indicate suitable target service producer NF instance(s) for an NF service instance selection, reselection, and routing of subsequent requests associated with a specific service producer NF resource (context) and NF service. Binding allows the service producer NF to indicate to the service consumer NF if a particular context should be bound to an NF service instance, NF instance, NF service set or NF set. Binding indication needs to be stored by the service consumer NF. Binding indications are further described in 3GPP TS 23.501 (v17.0.0), including sections 3.1 and 6.3.1.

Additionally, Routing Binding Indication is information included in a request or notification that can be used for discovery and associated selection of a suitable target. Routing binding indication has similar syntax as a binding indication, but it has different purpose. Routing binding indication provides the receiver (i.e., an SCP) with information enabling to route an HTTP request to an HTTP server that can serve the request. Routing binding indication is not stored by the receiver. Routing binding indications are further described in 3GPP TS 23.501 (v17.0.0), including sections 3.1, 6.3.1.0, and 7.1.2.

For direct communication, a service producer NF selects a target for the related notifications using the notification endpoint received in the subscription request. If the notification endpoint included in the subscription is not reachable, the received Binding Indication is used to discover an alternative notification endpoint. For indirect communication, the service producer NF includes the notification endpoint received in the subscription and may include a Routing Binding Indication with the same contents as the received Binding Indication. If the notification endpoint included in the subscription is not reachable, the SCP selects the target for the related notifications using the received Routing Binding Indication.

If the notification endpoint included in the explicit or implicit subscription is not reachable, the consumer NF Set information received in Binding Indication or Routing Binding Indication is used to discover an alternative notification endpoint. In general, an NF Set is a group of interchangeable NF instances of the same type, supporting the same services and the same Network Slice(s). The NF instances in the same NF Set may be geographically distributed but have access to the same context data.

FIG. 7 is a flow diagram of an exemplary procedure for a service consumer NF (NFc, 710) to obtain an access token for subscribing to notifications from a service producer NF (NFp, e.g., 610 in FIG. 6A).

In operation 1, the NFc requests an access token from the NRF using the Nnrf_AccessToken_Get Request service operation. The request includes the NF type of the NFc and requested “scope” including expected NF service name(s) and NF type(s). The request also includes “notification URI” since the operation semantics of the requested service type is “subscribe/notify”. NRF may verify whether the notification URI in the access token request match the corresponding information in the NFc's public key certificate or the NFc's NF profile in the NRF. In addition, NRF may verify whether the notification URI corresponds to a location with the same address as indicated by the FQDN or IP address registered for NFc in NRF.

Additionally, the NRF checks whether the NFc is authorized to access the requested services by subscription/notification. When the NFc is authorized, the NRF generates an access token with appropriate claims that include the “notification URI” provided by the NFc and sends the access token to NFc using the Nnrf_AccessToken_Get Response service operation. The NFc can then send the received access token to the NFp in a subscription request, such as shown in FIGS. 3-5 above. The NFp verifies the integrity and claims in the access token and, if successful, subscribes the NFp for notifications in accordance with the request.

Nevertheless, even if an NFc is authorized to receive notifications for a subscription, it is unclear how the NFc can be sure that a notification is coming from a notifier NF that is authorized to send notifications. For example, a notification URI can be obtained by an unauthorized third party, who could use it to send false notifications to provoke NFc actions with undesirable consequences.

As a more specific example, “deregCallbackUri” is a URI provided by AMF to receive (implicitly subscribed) notifications on deregistration of a UE, and is associated with unique information within AMF that identifies the UE to be deregistered. Thus, any NF that obtains this URI can use it to deregister the associated UE from AMF, such that the UE would be unable to access some or all of the services in the 5G network.

One possible approach is for the NRF to generate access tokens indicating that an NFp is authorized to send notifications for a subscription by an NFc, which is analogous to how the NRF can generate access tokens indicating that an NFc is authorized to receive such notifications (e.g., as shown in FIG. 7). However, this approach be overly complex because the NRF expects NFs to request access tokens to consume specific services of produced by other NFs, as indicated by the “scope” of an access token. This conventional arrangement is not directly applicable to notifications for several reasons. First, the roles of NFp and NFc are reversed relative to the conventional arrangement, since the NFp sends an HTTP request to a URI of the NFc. Second, there is no “service” or “scope” associated with the NFc receiving a notification.

Embodiments of the present disclosure address these and other problems, issues, and/or difficulties by providing novel, flexible, and efficient techniques whereby an entity (e.g., NFc) that creates a subscription to receive notifications generates an access token locally without involvement of the NRF, and sends it to the entity (e.g., NFp) that will send the notifications in accordance with the subscription. Once the notifying entity obtains an access token, it can provide the access token to the subscribing entity together with an associated notification. The access token can be secured by encryption, integrity protection, etc., based on which any entity that receives the access token can verify that it was generated by the subscribing entity. When received together with a notification, the information in the access token can be used by a subscribing entity to ensure that the notification is from an authorized sender to which the subscribing entity provided a valid access token.

Embodiments can improve security of the 5G SBA by mitigating various attack scenarios, including the one summarized above. Furthermore, embodiments can provide such benefits without requiring or relying on support from NRF or other authentication server in the communication network. This makes the solution less complex and easier to implement than conventional solutions (e.g., OAuth) that rely on such functionality in the communication network.

Embodiments will be described below in the context of a procedure involving four entities of a communication network: NF that subscribes to notifications (“subscriber NF”), NF that receives notifications based on the subscription (“receiver NF”, e.g., NFc), NF that provides notifications based on the subscription (“notifier NF”, e.g., NFp), and NRF. In some embodiments, subscriber NF and receiver NF may be identical (e.g., as shown in FIG. 3 above). In other embodiments, subscriber NF and receiver NF may be different NFs (e.g., as shown in FIGS. 4-5 above).

The subscriber NF or receiver NF may register its NF profile in NRF, including notification authorization information. This notification authorization information may include Notification Type (e.g., Deregistration Notification, P-CSCF Restoration Notification, Data Restoration Notification, etc.) and information about the notifier NF (e.g., NF type, NF (service) instance or list, NF (service) set, etc.). For example, the notification authorization information could be called allowedNotificationperNfType or allowedNotificationperNfinstances.

In the delegated subscribe-notify case (e.g., such as shown in FIG. 4), the first step of the subscribe-notify interaction may be a service request by the receiver NF to the subscriber NF that triggers the subscriber NF to subscribe on behalf of the receiver NF. This request may contain the callback (or notification) URI used by the receiver NF to receive the notifications.

The subscriber NF sends a request message to the notifier NF, with an explicit or implicit subscription. In some embodiments, this request includes the NF type and/or an NF set of the receiver NF. In some embodiments, this request includes the Notification Type, which may be associated with a notification callback reference URI. In some embodiments, the information about the notifier NF (e.g., NF type, NF (service) instance or list, NF (service) set, etc.) may be associated with a notification callback reference URI. The following is an example notification callback reference URI according to these embodiments:

$$URI = scheme ″ : ″″ // \\ ″ host [ ″ : ″ port ] / [ Notification Type ] / [ notifier NF info ] / path$$

In the case of a default notification subscription, the notifier NF performs NF discovery towards NRF to get the callback URI and other information about the receiver NF to be used in a request for an access token for notifications (described below). When the notification subscription is by an intermediate NF on behalf of the receiver NF, the notifier NF gets the callback URI and other information about the receiver NF from the intermediate NF who sends the subscription request.

The notifier NF then sends an access token request to the NRF acting as authorization server. In some embodiments, the access token request includes an indication that the requested access token is for sending notifications. In other embodiments, the access token request is sent to a dedicated NRF URI that is specific to a notification authorization service (e.g., access token service URI) of the NRF. In other embodiments, the access token request includes the NF type and/or an NF set of the receiver NF. In some embodiments, the access token request may include the Notification Type, notification callback reference URI, subscription ID, and/or subscription lifetime (if available for an explicit subscription).

Upon receiving the request, the NRF (authorization server) checks whether the notifier NF is authorized, e.g., based on the previously registered NF profile of subscriber/receiver NF. If authorized, the NRF sends an access token to the notifier NF.

In some embodiments, the access token includes an indication that it is for sending notifications. In some embodiments, the access token contains the NF type and/or an NF set of the receiver NF, an NF set of the notifier NF, Notification Type, notification callback reference URI, and/or subscription ID. The access token may include a lifetime, which can be determined by the NRF based on the lifetime of the corresponding subscription (if available, as mentioned above).

At some point after receiving the access token, the notifier NF sends a notification to the receiver NF according to the earlier subscription. The notification contains the received access token. In some embodiments, the receiver NF checks whether it is the intended recipient of this notification based on subscription ID, NF type of the receiver NF, and/or NF set of the receiver NF in the access token. In some embodiments, the receiver NF checks for consistency between NF type of the receiver NF, NF set of the receiver NF, and/or notification callback reference URI in the access token.

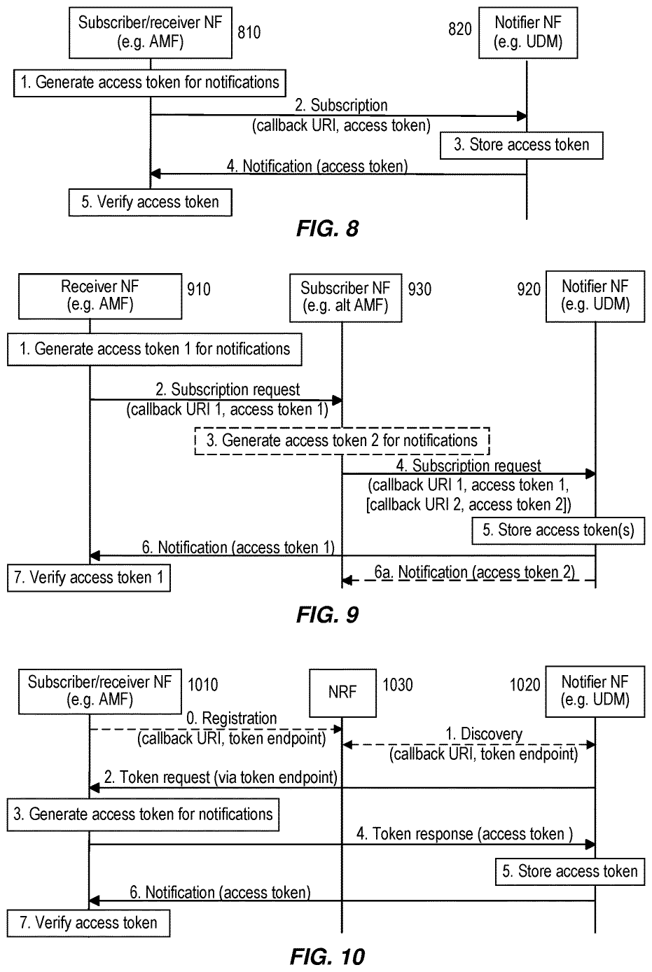

The embodiments summarized above will be in more detail based on FIGS. 8-10, which show signaling diagrams of various procedures for obtaining and using an access token for sending notifications, according to various embodiments of the present disclosure. Although the operations shown in FIGS. 8-10 are given numerical labels, this is intended to facilitate the following description rather than to require any particular order of the operations, unless expressly stated otherwise.

FIG. 8 shows a signaling diagram between a subscriber/receiver NF (810) and a notifier NF (820), according to some embodiments. In the scenario shown in FIG. 8, the subscriber NF and the receiver NF are identical.

In operation 1, the subscriber/receiver NF generates an access token for notifications pertaining to a subscription and cryptographically secures the access token using locally generated key material. This key material may be generated specifically for the procedure shown in FIG. 8, or it may be existing and/or generated for other purposes.

The security applied to the access token should enable the subscriber/receiver NF to verify that a later-received access token is the same as was generated in operation 1. For example, the subscriber/receiver NF can digitally sign the token using a private key of a locally generated public-private key pair. As another example, the subscriber/receiver NF can append to the access token a message authentication code (MAC) generated using a private key of a locally generated public-private key pair. As another example, the subscriber/receiver NF can append a cryptographic hash of the access token that is computed using the locally generated key material.

In any case, the security applied to the access token by the subscriber/receiver NF allows it to reliably determine that a later-received access token was generated by the subscriber/receiver NF and not by another entity. Moreover, the security applied to the access token by the subscriber/receiver NF allows it to reliably determine that the later-received token was not modified by another entity. In some embodiments, the security applied to the access token by the subscriber/receiver NF allows it to reliably determine the time that a later-received token was generated, thereby enabling the subscriber/receiver NF to control a lifetime or validity duration for the access token.

In some embodiments, the access token can include one or more of the following:
an indication of whether the subscription is implicit or explicit;
an identifier of the subscription;
a lifetime or validity duration for the subscription;
a notification type associated with the subscription;
a callback URI at which the receiver NF can receive the notifications;
a callback URI schema, from which callback URIs for notifications to the subscriber/receiver NF can be generated;
one or more of the following associated with the subscriber/receiver NF: NF type, binding indication, NF set, NF service set, one or more NF instances, and one or more NF service instances; and
one or more of the following associated with the notifier NF: NF type, NF set, and one or more NF instances.

In some embodiments, the notification type and the information associated with the notifier NF (e.g., NF type, NF set, NF service instance(s)) may be associated with the callback (or notification) URI. The following is an example callback URI according to these embodiments:

$$URI = scheme ″ : ″″ // \\ ″ host [ ″ : ″ port ] / [ Notification Type ] / [ notifier NF info ] / path$$

In operation 2, the subscriber/receiver NF sends the notifier NF a subscription request for notifications. The subscription request includes the access token generated in operation 1, along with one or more of the following information:
an indication of whether the subscription is implicit or explicit;
an identifier of the subscription;
a lifetime or validity duration for the subscription;
a notification type associated with the subscription;
a callback URI at which the receiver NF can receive the notifications;
a callback URI schema, from which callback URIs for notifications to the subscriber/receiver NF can be generated;
one or more of the following associated with the subscriber/receiver NF: NF type, binding indication, NF set, NF service set, one or more NF instances, and one or more NF service instances; and
one or more of the following associated with the notifier NF: NF type, NF set, and one or more NF instances; and
an indication (e.g., URI) of where to obtain a public key corresponding to a private key used to secure (e.g., sign) the access token.
   For example, including the various information associated with the notifier NF enables an alternative notifier NF (e.g., NFp) to use the access token when taking over servicing the subscription due to failure and/or unavailability of the notifier NF originally servicing the subscription.

In operation 3, the notifier NF stores the access token and at least a portion of the other information received in the subscription request of operation 2. In operation 4, after occurrence of a triggering condition associated with the subscription (e.g., availability of data), the notifier NF sends the subscriber/receiver NF a notification according to the subscription. The notification includes the access token previously received and stored. For example, the notifier NF sends the notification as an HTTP/HTTPS request to the callback URI included with the subscription, with the access token being included in a header of the HTTP/HTTPS request.

In operation 5, the subscriber/receiver NF extracts the access token from the notification and verifies it. In some embodiments, if the subscriber/receiver NF locally stored the access token generated in operation 1, it compares the locally stored access token with the access token received in operation 4. If there is a match or correspondence between the two access tokens, then the subscriber/receiver NF determines that the notification is from an authorized source.

In other embodiments, if the subscriber/receiver NF did not locally store the access token generated in operation 1, it performs cryptographic operations on the received access token to confirm that it was generated by the subscriber/receiver NF, that it was not modified by another entity, and that its lifetime or validity duration has not expired. If these conditions are confirmed, then the subscriber/receiver NF determines that the notification is from an authorized source.

FIG. 9 shows a signaling diagram between a receiver NF (910), a subscriber NF (930), and a notifier NF (920), according to other embodiments of the present disclosure. In the scenario shown in FIG. 9, the subscriber NF is a different entity than the receiver NF. In particular, the subscriber NF is arranged to subscribe to notifications on behalf of the receiver NF.

Operation 1 is substantially identical to operation 1 of FIG. 8, described above. For clarity, the access token generated in FIG. 9 operation 1 will be referred to as “first access token” or “access token 1” in the following description. Operation 2 is substantially identical to operation 2 of FIG. 8, described above, except that the subscription request is sent to the subscriber NF rather than directly to the notifier NF. The subscription request can include any of the information discussed above in relation to FIG. 8 operation 2. In the specific example shown in FIG. 9, the subscription request includes a callback URI for the receiver NF, which will be referred to as “first callback URI” or “callback URI 1” in the following description.

In some embodiments, the subscriber NF may also be interested in receiving the same notifications as the receiving NF. If so, in operation 3, the subscriber NF generates a second access token (“access token 2”) and cryptographically secures the second access token using locally generated key material. The second access token can have any of the same characteristics and/or content as the first access token generated in operation 1, except that they relate to the subscriber NF rather than the receiver NF.

In operation 4, the subscriber NF forwards the subscription request received in operation 2 to the notifier NF. In case the subscriber NF is also subscribing to the same notifications as the receiver NF, the subscriber NF includes in the subscription request the second access token and a second callback URI for the subscriber NF, i.e., at which the subscriber NF can receive notifications in a similar manner as the receiving NF. Operation 5 is substantially similar to FIG. 8 operation 3, except that the notifier NF stores all access tokens and subscription information received in operation 4.

In operation 6, after occurrence of a triggering condition associated with the subscription (e.g., availability of data), the notifier NF sends the receiver NF a notification according to the subscription. The notification includes the first access token previously received and stored. For example, the notifier NF sends the notification as an HTTP/HTTPS request to the first callback URI included with the subscription, with the first access token being included in a header of the HTTP/HTTPS request. In operation 7, the receiver NF extracts the access token from the notification and verifies it in any of the ways described above in relation to FIG. 8 operation 5.

In operation 6a, if the subscriber NF also subscribed to the same notifications as the receiver NF, the notifier NF sends the subscriber NF a notification according to the subscription. The notification includes the second access token previously received and stored. For example, the notifier NF sends the notification as an HTTP/HTTPS request to the second callback URI included with the subscription, with the second access token being included in a header of the HTTP/HTTPS request. Although not shown, the subscriber NF extracts the second access token from the notification and verifies it in any of the ways described above in relation to FIG. 8 operation 5. This verification can be considered an operation 7a.

In a variant of the procedure shown in FIG. 9, the receiver NF can send the first access token to the subscriber NF in a service request, which triggers the subscriber NF to subscriber to notifications from the notifier NF on behalf of the receiver NF. In a similar manner as shown in FIG. 9, the subscriber NF includes the first access token in the subscription request, optionally along with a second access token and second callback URI associated with the subscriber NF.

FIG. 10 shows a signaling diagram between a subscriber/receiver NF (1010), an NRF (1030), and a notifier NF (1020), according to other embodiments of the present disclosure. In the scenario shown in FIG. 10, the subscriber NF and the receiver NF are identical.

The scenario shown in FIG. 10 is based on a default subscription, such that there is no explicit subscription requests sent by the subscriber/receiver NF to the notifier NF. Rather, the notifier NF obtains the subscriber/receiver NF's callback (or notification) from NRF or based on locally provisioned information in the notifier NF.

In operation 0, the subscriber/receiver NF registers its NF profile in the NRF. The registered NF profile includes a default callback URI and a token endpoint (e.g., URI) from which an access token required to use the callback URI can be obtained. Alternately, the registered NF profile can include a default notification credential (e.g., access token) associated with the default callback URI.

In operation 1, which is optional, the notifier NF obtains the default callback URI and token endpoint for the subscriber/receiver NF from the NRF via a discovery procedure (e.g., sending a discovery request and receiving a discovery response). Otherwise, the notifier NF obtains the default callback URI and token endpoint for the subscriber/receiver NF from locally provisioned information in the notifier NF.

In operation 2, the notifier NF sends a token request to the token endpoint. Upon receiving this request, in operation 3, the subscriber/receiver NF generates an access token for notifications. Operation 3 can be performed in a similar manner as FIG. 8 operation 1, with the generated access token including any of the information discussed above in relation to that operation. In operation 4, the subscriber/receiver NF sends the notifier NF a token response that includes the requested access token. Operations 5-7 are substantially identical to FIG. 8 operation 3-5, discussed above.

In a variant of the procedure shown in FIG. 10, rather than obtaining an access token via operations 2-4, the notifier NF can obtain a default notification credential (e.g., access token) from the NRF in operation 1. For example, a default access token may be included in the NF profile registered by the subscriber/receiver NF in operation 0. In such variants, operations 2-4 are omitted.

In operation 0, the subscriber/receiver NF registers its NF profile in the NRF. The NF profile includes a callback URI schema for notifications and allowed NF information, which identifies NF types, NF sets, and/or NF instances that are allowed to send notifications to the subscriber/receiver NF. In operation 1a, the notifier NF sends a discovery request to the NRF. The discovery request may indicate a notification type that the notifier NF provides. In operation 1b, after identifying that the subscriber/receiver NF is registered for this notification type, the NRF sends the notifier NF a discovery response that includes a callback (or notification) URI associated with the subscriber/receiver NF. Optionally, the discovery response includes a callback URI schema for notifications, e.g., as registered with the NRF in operation 0. Operations 2-4 are identical to respective operations 2-4 of FIG. 9, described above.

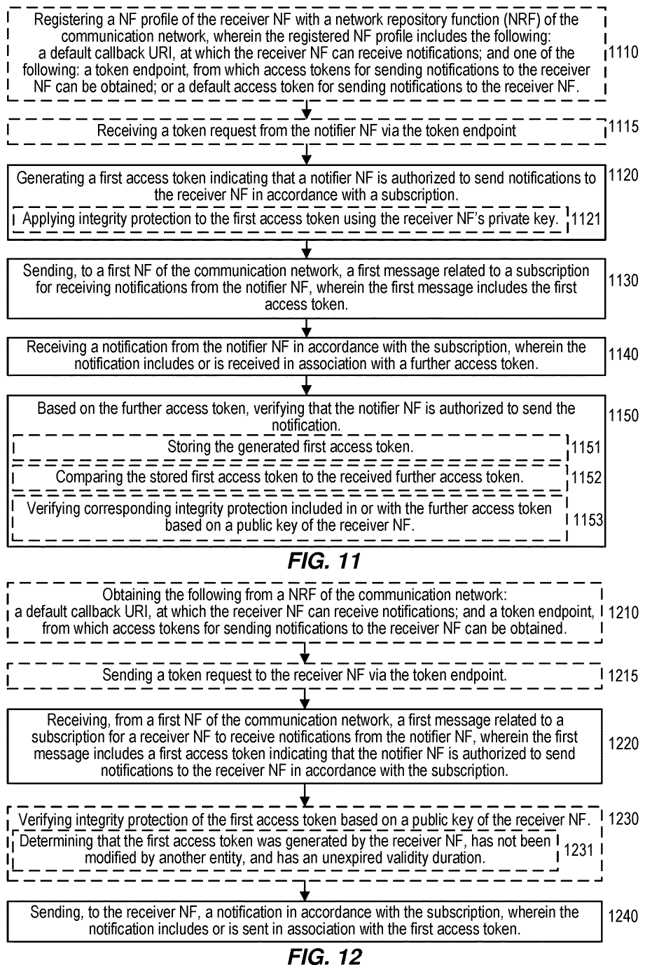

The embodiments described above can be further illustrated with reference to FIGS. 11-14, which show exemplary methods (e.g., procedures) for a receiver NF, a notifier NF, an NRF, and a subscriber NF, respectively. Put differently, various features of the operations described below correspond to various embodiments described above. The exemplary methods shown in FIGS. 11-14 can be used cooperatively (e.g., with each other and with other procedures described herein) to provide benefits, advantages, and/or solutions to problems described herein. Although the exemplary methods are illustrated in FIGS. 11-14 by specific blocks in particular orders, the operations corresponding to the blocks can be performed in different orders than shown and can be combined and/or divided into blocks and/or operations having different functionality than shown. Optional blocks and/or operations are indicated by dashed lines.

More specifically, FIG. 11 illustrates an exemplary method (e.g., procedure) for a receiver NF arranged to receive notifications from notifier NFs of a communication network (e.g., 5GC), according to various embodiments of the present disclosure. The exemplary method shown in FIG. 11 can be performed by various NFs (or network nodes hosting the same) such as described elsewhere herein.

The exemplary method includes the operations of block 1120, where the receiver NF generates a first access token indicating that a notifier NF is authorized to send notifications to the receiver NF in accordance with a subscription. The exemplary method also includes the operations of block 1130, where the receiver NF sends, to a first NF of the communication network, a first message related to a subscription for receiving notifications from a notifier NF of the communication network. The first message includes the first access token. The exemplary method also includes the operations of block 1140, where the receiver NF receives a notification from the notifier NF in accordance with the subscription. The notification includes or is received in association with a further access token. The exemplary method also includes the operations of block 1150, where based on the further access token, the receiver NF verifies that the notifier NF is authorized to send the notification.

In some embodiments, the first NF is the notifier NF and the first message is a subscription request for notifications from the notifier NF. FIG. 8 is an example of these embodiments. In other embodiments, the first NF is a subscriber NF different from the receiver NF and the first message is one of the following: a subscription request for notifications from the notifier NF, or a service request indicating that the subscriber NF should subscribe to notifications on behalf of the receiver NF. FIG. 9 is an example of these embodiments.

In other embodiments, the exemplary method also includes the operations of block 1110, where the receiver NF registers its NF profile with an NRF of the communication network. The registered NF profile includes a default callback uniform resource identifier (URI), at which the receiver NF can receive notifications, and one of the following:
a token endpoint, from which access tokens for sending notifications to the receiver NF can be obtained; or
a default access token for sending notifications to the receiver NF.

In some of these embodiments, the exemplary method also includes the operations of block 1115, wherein the receiver NF receives a token request from the notifier NF via the token endpoint. The first access token is generated in response to the token request, the first message is a token response, and the notification is received at the default callback URI. FIG. 10 is an example of these embodiments.

In some embodiments, the first access token includes one or more of the following information:
an indication of whether the subscription is implicit or explicit;
an identifier of the subscription;
a validity duration associated with the subscription;
a notification type associated with the subscription;
a callback URI at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances; and
one or more of the following associated with the notifier NF: NF type, NF set, and one or more NF instances.

In some embodiments, the first message includes one or more of the following information:
an indication of whether the subscription is implicit or explicit;
an identifier of the subscription;
a validity duration associated with the subscription;
a notification type associated with the subscription;
a callback URI at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances;
one or more of the following associated with the notifier NF: NF type, NF set, and one or more NF instances; and
a URI from which a public key of the receiver NF can be obtained.

In some embodiments, verifying that the notifier NF is authorized to send the notification in block 1150 includes the operations of sub-blocks 1151-1152, where the receiver NF stores the generated first access token and compares the stored first access token to the received further access token. In such case, a match or correspondence between the first access token and the further access token indicates that the notifier NF is authorized to send the notification.

In other embodiments, such as when the receiver NF does not store the generated first access token, generating the first access token in block 1120 includes the operations of sub-block 1121, where the receiver NF applies integrity protection to the first access token using a private key of the receiver NF. Also, verifying that the notifier NF is authorized to send the notification in block 1150 includes the operations of sub-block 1153, where the receiver NF verifies corresponding integrity protection included in or with the further access token based on a public key of the receiver NF.

In some of these embodiments, the integrity protection applied to the first access token comprises one of the following generated using the private key: digital signature, message authentication code, and cryptographic hash. In some of these embodiments, the public key and the private key are locally generated by the receiver NF. In some of these embodiments, verifying the corresponding integrity protection included in or with the further access token in sub-block 1153 includes determining that the further access token was generated by the receiver NF, has not been modified by another entity, and has an unexpired validity duration.

In some embodiments, the first message includes a second access token indicating that the receiver NF is authorized to subscribe to the notifications from the notifier NF. In some embodiments, the receiver NF is an AMF and/or the notifier NF is a UDM function.

In addition, FIG. 12 illustrates an exemplary method (e.g., procedure) for a notifier NF arranged to send notifications to receiver NFs in a communication network (e.g., 5GC), according to various embodiments of the present disclosure. The exemplary method shown in FIG. 12 can be performed by various NFs (or network nodes hosting the same) such as described elsewhere herein.

The exemplary method includes the operations of block 1220, where the notifier NF receives, from a first NF of the communication network, a first message related to a subscription for a receiver NF to receive notifications from the notifier NF. The first message includes a first access token indicating that the notifier NF is authorized to send notifications to the receiver NF in accordance with the subscription The exemplary method also includes the operations of block 1240, where the notifier NF sends to the receiver NF a notification in accordance with the subscription request. The notification includes or is sent in association with the first access token.

In some embodiments, the first message is a subscription request for notifications from the notifier NF and the first NF is the receiver NF or a subscriber NF authorized to subscribe to notifications on behalf of the receiver NF. FIGS. 8-9 are examples of these embodiments. In some of these embodiments, the subscription request is for the receiver NF to receive notifications from the notifier NF. In other of these embodiments, the subscription request is for the receiver NF and the subscriber NF to receive notifications from the notifier NF, and the first message includes a further first access token indicating that the notifier NF is authorized to send notifications to the subscriber NF in accordance with the subscription.

In other embodiments, the first NF is the notifier NF and the first message is a token response. FIG. 10 shows an example of these embodiments. In some of these embodiments, the exemplary method also includes the operations of block 1210, where the notifier NF obtains the following from an NRF of the communication network:
a default callback URI, at which the receiver NF can receive notifications; and
a token endpoint, from which access tokens for sending notifications to the receiver NF can be obtained.

The exemplary method also includes the operations of block 1215, where the notifier NF sends a token request to the receiver NF via the token endpoint. In such embodiments, the token response is responsive to the token request and the notification is sent to the default callback URI.

In various embodiments, the first access token can include any of the information described above in relation to receiver NF embodiments shown in FIG. 11. In various embodiments, the first message can include any of the information described above in relation to receiver NF embodiments shown in FIG. 11.

In some embodiments, the first access token is integrity protected based on a private key of the receiver NF and the exemplary method also includes the operations of block 1230, where the notifier NF verifies the integrity protection of the first access token based on a public key of the receiver NF. In some of these embodiments, the integrity protection of the first access token comprises one of the following generated based on the private key of the receiver NF: digital signature, message authentication code, and cryptographic hash. In some of these embodiments, verifying the integrity protection of the first access token in block 1230 includes the operations of sub-block 1231, where the notifier NF determines that the first access token was generated by the receiver NF, has not been modified by another entity, and has an unexpired validity duration.

In some embodiments, the first message includes a second access token indicating that the receiver NF is authorized to subscribe to the notifications from the notifier NF. In some embodiments, the receiver NF is an AMF and/or the notifier NF is a UDM function.

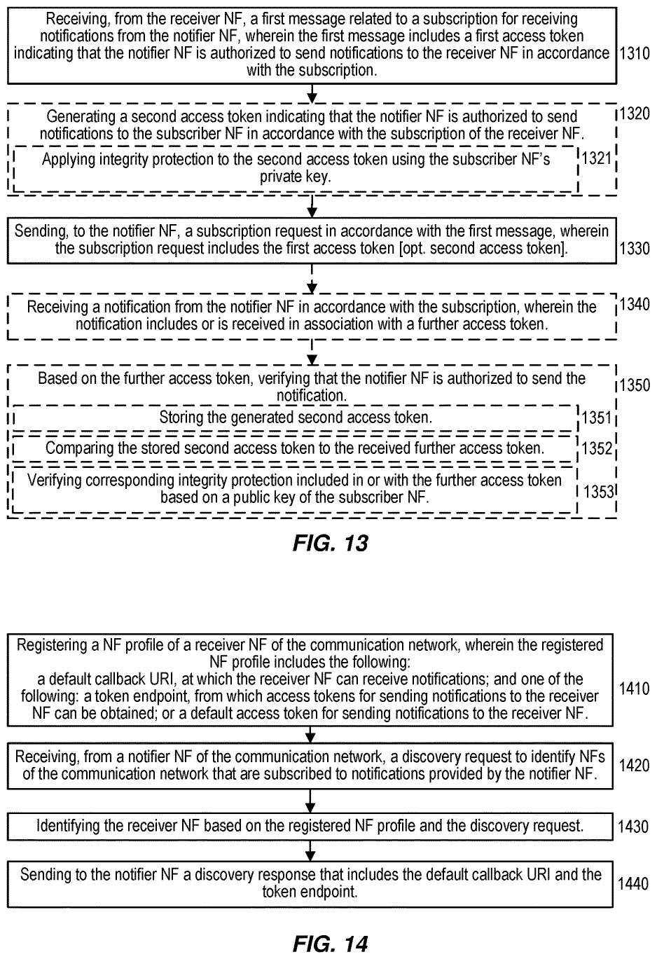

In addition, FIG. 13 illustrates an exemplary method (e.g., procedure) for a subscriber NF arranged to subscribe to notifications from a notifier NF of a communication network on behalf of a receiver NF of the communication network (e.g., 5GC), according to various embodiments of the present disclosure. The exemplary method shown in FIG. 13 can be performed by various NFs (or network nodes hosting the same) such as described elsewhere herein.

The exemplary method includes the operations of block 1310, where the subscriber NF receives, from the receiver NF, a first message related to a subscription for receiving notifications from the notifier NF. The first message includes a first access token indicating that the notifier NF is authorized to send notifications to the receiver NF in accordance with the subscription. The exemplary method also includes the operations of block 1330, where the subscriber NF sends to the notifier NF a subscription request in accordance with the first message. The subscription request includes the first access token.

In some embodiments, the first message is a subscription request for notifications from the notifier NF. In other embodiments, the first message is a service request indicating that the subscriber NF should subscribe to notifications from the notifier NF on behalf of the receiver NF. Some examples of these different embodiments were discussed above in relation to FIG. 9 In some embodiments, the exemplary method also includes the operations of block 1320, where the subscriber NF generates a second access token indicating that the notifier NF is authorized to send notifications to the subscriber NF in accordance with the subscription of the receiver NF. In such case, the subscription request to the notifier NF includes the second access token, as well as the first access token received from the receiver NF.

In some of these embodiments, the exemplary method also includes the following operations, labelled with corresponding block numbers:
(1340) receiving a notification from the notifier NF in accordance with the subscription, wherein the notification includes or is received in association with a further access token; and
(1350) based on the further access token, verifying that the notifier NF is authorized to send the notification.

In some of these embodiments, verifying that the notifier NF is authorized to send the notification in block 1350 includes the operations of sub-blocks 1351-1352, where the subscriber NF stores the generated second access token and compares the stored second access token to the received further access token. A match or correspondence between the second access token and the further access token indicates that the notifier NF is authorized to send the notification.

In other embodiments, such as when the subscriber NF does not store the generated second access token, generating the second access token in block 1320 includes the operations of sub-block 1321, where the subscribe NF applies integrity protection to the second access token using a private key of the subscriber NF. Also, verifying that the notifier NF is authorized to send the notification in block 1350 includes the operations of sub-block 1353, where the subscriber NF verifies corresponding integrity protection included in or with the further access token based on a public key of the subscriber NF.

In some of these embodiments, the integrity protection applied to the second access token comprises one of the following generated using the private key of the subscriber NF: digital signature, message authentication code, and cryptographic hash. In some of these embodiments, the public key and the private key are locally generated by the subscriber NF. In some of these embodiments, verifying corresponding integrity protection included in or with the further access token in sub-block 1353 includes determining that the further access token was generated by the subscriber NF, has not been modified by another entity, and has an unexpired validity duration.

In various embodiments, the first access token can include any of the information described above in relation to receiver NF embodiments shown in FIG. 11. In various embodiments, the first message can include any of the information described above in relation to receiver NF embodiments shown in FIG. 11. In some embodiments, the subscription request includes at least a portion of the information included in the first message.

In some embodiments, one or more of the following applies: the receiver NF is a first AMF, the notifier NF is a UDM function, and the subscriber NF is a second AMF different from the first AMF.

In addition, FIG. 14 illustrates an exemplary method (e.g., procedure) for an NRF of a communication network (e.g., 5GC), according to various embodiments of the present disclosure. The exemplary method shown in FIG. 14 can be performed by an NRF (or network node hosting the same) such as described elsewhere herein.

The exemplary method includes the operations of block 1410, where the NRF registers a NF profile of a receiver NF of the communication network. The registered NF profile includes a default callback URI, at which the receiver NF can receive notifications, and one of the following:
a token endpoint, from which access tokens for sending notifications to the receiver NF can be obtained; or
a default access token for sending notifications to the receiver NF.

The exemplary method also includes the operations of block 1420, where the NRF receives, from a notifier NF of the communication network, a discovery request to identify NFs of the communication network that are subscribed to notifications provided by the notifier NF. The exemplary method also includes the operations of block 1430, where the NRF identifies the receiver NF based on the registered NF profile and the discovery request. The exemplary method also includes the operations of block 1440, where the NRF sends to the notifier NF a discovery response that includes the default callback URI and the token endpoint.

In some embodiments, the receiver NF is an AMF and/or the notifier NF is a UDM function.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

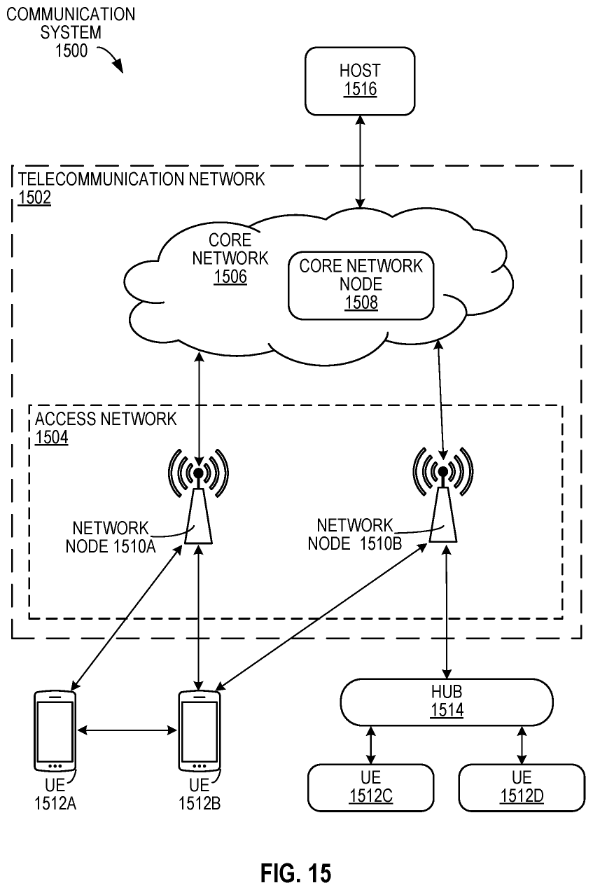

FIG. 15 shows an example of a communication system 1500 in accordance with some embodiments. In this example, communication system 1500 includes a telecommunication network 1502 that includes an access network 1504 (e.g., RAN) and a core network 1506, which includes one or more core network nodes 1508. Access network 1504 includes one or more access network nodes, such as network nodes 1510a-b (one or more of which may be generally referred to as network nodes 1510), or any other similar 3GPP access node or non-3GPP access point. Network nodes 1510 facilitate direct or indirect connection of UEs, such as by connecting UEs 1512a-d (one or more of which may be generally referred to as UEs 1512) to core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1500 may include any number of wired or wireless networks, network nodes, UEs, and/or any other components or systems that may facilitate or participate in the communication of data and/or signals whether via wired or wireless connections. Communication system 1500 may include and/or interface with any type of communication, telecommunication, data, cellular, radio network, and/or other similar type of system.

UEs 1512 may be any of a wide variety of communication devices, including wireless devices arranged, configured, and/or operable to communicate wirelessly with network nodes 1510 and other communication devices. Similarly, network nodes 1510 are arranged, capable, configured, and/or operable to communicate directly or indirectly with UEs 1512 and/or with other network nodes or equipment in telecommunication network 1502 to enable and/or provide network access, such as wireless network access, and/or to perform other functions, such as administration in telecommunication network 1502.

In the depicted example, core network 1506 connects network nodes 1510 to one or more hosts, such as host 1516. These connections may be direct or indirect via one or more intermediary networks or devices. In other examples, network nodes may be directly coupled to hosts. Core network 1506 includes one or more core network nodes (e.g., 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

For example, one or more core network nodes 1508 can be configured to perform operations attributed to various NFs in the descriptions herein of various methods or procedures. As a more specific example, the one or more core network nodes 1508 can be configured to perform operations attributed to a receiver NF (e.g., AMF), a notifier NF (e.g., UDM), an NRF, and a subscriber NF (e.g., AMF).

Host 1516 may be under the ownership or control of a service provider other than an operator or provider of access network 1504 and/or telecommunication network 1502, and may be operated by the service provider or on behalf of the service provider. Host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1502 is a cellular network that implements 3GPP standardized features. Accordingly, telecommunication network 1502 may support network slicing to provide different logical networks to different devices that are connected to telecommunication network 1502. For example, telecommunication network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1512 are configured to transmit and/or receive information without direct human interaction. For instance, a UE may be designed to transmit information to access network 1504 on a predetermined schedule, when triggered by an internal or external event, or in response to requests from access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1514 communicates with access network 1504 to facilitate indirect communication between one or more UEs (e.g., UE 1512c and/or 1512d) and network nodes (e.g., network node 1510b). In some examples, hub 1514 may be a controller, router, content source and analytics, or any of the other communication devices described herein regarding UEs. For example, hub 1514 may be a broadband router enabling access to core network 1506 for the UEs. As another example, hub 1514 may be a controller that sends commands or instructions to one or more actuators in the UEs. Commands or instructions may be received from the UEs, network nodes 1510, or by executable code, script, process, or other instructions in hub 1514. As another example, hub 1514 may be a data collector that acts as temporary storage for UE data and, in some embodiments, may perform analysis or other processing of the data. As another example, hub 1514 may be a content source. For example, for a UE that is a VR headset, display, loudspeaker or other media delivery device, hub 1514 may retrieve VR assets, video, audio, or other media or data related to sensory information via a network node, which hub 1514 then provides to the UE either directly, after performing local processing, and/or after adding additional local content. In still another example, hub 1514 acts as a proxy server or orchestrator for the UEs, in particular in if one or more of the UEs are low energy IoT devices.

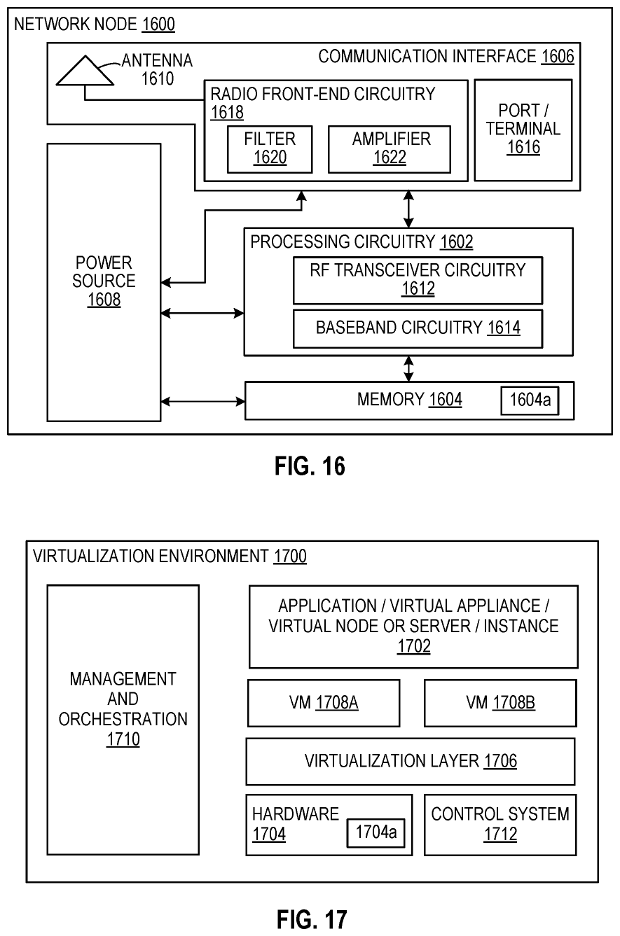

FIG. 16 shows a network node 1600 in accordance with some embodiments. Examples of network nodes include, but are not limited to, access points (e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

For example, one or more network nodes 1600 can be configured to perform operations attributed to various NFs in the descriptions herein of various methods or procedures. As a more specific example, the one or more network nodes 1600 can be configured to perform operations attributed to a receiver NF (e.g., AMF), a notifier NF (e.g., UDM), an NRF, and a subscriber NF (e.g., AMF).

Network node 1600 includes processing circuitry 1602, a memory 1604, a communication interface 1606, and a power source 1608. Network node 1600 may be composed of multiple physically separate components (e.g., a NodeB component and a RNC component, or a BTS component and a BSC component, etc.), which may each have their own respective components. In certain scenarios in which network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). Network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

Processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as memory 1604, to provide network node 1600 functionality.

In some embodiments, processing circuitry 1602 includes a system on a chip (SOC). In some embodiments, processing circuitry 1602 includes one or more of radio frequency (RF) transceiver circuitry 1612 and baseband processing circuitry 1614. In some embodiments, RF transceiver circuitry 1612 and baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

Memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1602. Memory 1604 may store any suitable instructions, data, or information, including a computer program, software, an application including one or more of logic, rules, code, tables, and/or other instructions (collectively denoted computer program product 1604a) capable of being executed by processing circuitry 1602 and utilized by network node 1600. Memory 1604 may be used to store any calculations made by processing circuitry 1602 and/or any data received via communication interface 1606. In some embodiments, processing circuitry 1602 and memory 1604 is integrated.

Communication interface 1606 is used in wired or wireless communication of signaling and/or data between a network node, access network, and/or UE. As illustrated, communication interface 1606 comprises port(s)/terminal(s) 1616 to send and receive data, for example to and from a network over a wired connection. Communication interface 1606 also includes radio front-end circuitry 1618 that may be coupled to, or in certain embodiments a part of, antenna 1610. Radio front-end circuitry 1618 comprises filters 1620 and amplifiers 1622. Radio front-end circuitry 1618 may be connected to an antenna 1610 and processing circuitry 1602. The radio front-end circuitry may be configured to condition signals communicated between antenna 1610 and processing circuitry 1602. Radio front-end circuitry 1618 may receive digital data that is to be sent out to other network nodes or UEs via a wireless connection. Radio front-end circuitry 1618 may convert the digital data into a radio signal having the appropriate channel and bandwidth parameters using a combination of filters 1620 and/or amplifiers 1622. The radio signal may then be transmitted via antenna 1610. Similarly, when receiving data, antenna 1610 may collect radio signals which are then converted into digital data by radio front-end circuitry 1618. The digital data may be passed to processing circuitry 1602. In other embodiments, the communication interface may comprise different components and/or different combinations of components.

In certain alternative embodiments, network node 1600 does not include separate radio front-end circuitry 1618, instead, processing circuitry 1602 includes radio front-end circuitry and is connected to antenna 1610. Similarly, in some embodiments, all or some of RF transceiver circuitry 1612 is part of communication interface 1606. In still other embodiments, communication interface 1606 includes one or more ports or terminals 1616, radio front-end circuitry 1618, and RF transceiver circuitry 1612, as part of a radio unit (not shown), and communication interface 1606 communicates with baseband processing circuitry 1614, which is part of a digital unit (not shown).

Antenna 1610 may include one or more antennas, or antenna arrays, configured to send and/or receive wireless signals. Antenna 1610 may be coupled to radio front-end circuitry 1618 and may be any type of antenna capable of transmitting and receiving data and/or signals wirelessly. In certain embodiments, antenna 1610 is separate from network node 1600 and connectable to network node 1600 through an interface or port.

Antenna 1610, communication interface 1606, and/or processing circuitry 1602 may be configured to perform any receiving operations and/or certain obtaining operations described herein as being performed by the network node. Any information, data and/or signals may be received from a UE, another network node and/or any other network equipment. Similarly, antenna 1610, communication interface 1606, and/or processing circuitry 1602 may be configured to perform any transmitting operations described herein as being performed by the network node. Any information, data and/or signals may be transmitted to a UE, another network node and/or any other network equipment.

Power source 1608 provides power to the various components of network node 1600 in a form suitable for the respective components (e.g., at a voltage and current level needed for each respective component). Power source 1608 may further comprise, or be coupled to, power management circuitry to supply the components of network node 1600 with power for performing the functionality described herein. For example, network node 1600 may be connectable to an external power source (e.g., the power grid, an electricity outlet) via an input circuitry or interface such as an electrical cable, whereby the external power source supplies power to power circuitry of power source 1608. As a further example, power source 1608 may comprise a source of power in the form of a battery or battery pack which is connected to, or integrated in, power circuitry. The battery may provide backup power should the external power source fail.

Embodiments of network node 1600 may include additional components beyond those shown in FIG. 16 for providing certain aspects of the network node's functionality, including any of the functionality described herein and/or any functionality necessary to support the subject matter described herein. For example, network node 1600 may include user interface equipment to allow input of information into network node 1600 and to allow output of information from network node 1600. This may allow a user to perform diagnostic, maintenance, repair, and other administrative functions for network node 1600.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment 1700 to implement some of the features, functions, and/or benefits of some of the embodiments disclosed herein.

For example, various NFs (or portions thereof) described herein in relation to other figures can be implemented as virtual network functions 1702 in virtualization environment 1700. As a more specific example, a receiver NF (e.g., AMF), a notifier NF (e.g., UDM), an NRF, and/or a subscriber NF (e.g., AMF) can be implemented as virtual network functions 1702 in virtualization environment 1700.

Hardware 1704 includes processing circuitry, memory that stores software and/or instructions (collectively denoted computer program product 1704a) executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors, VMMs), provide VMs 1708a-b (one or more of which may be generally referred to as VMs 1708), and/or perform any of the functions, features and/or benefits described in relation with some embodiments described herein. Virtualization layer 1706 may present a virtual operating platform that appears like networking hardware to the VMs 1708.

VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1708 may be a software implementation of a physical machine that runs programs as if they were executing on a physical, non-virtualized machine. Each VM 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of hardware 1704 and corresponds to application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of control system 1712 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:
A1. A method performed by a receiver network function (NF) arranged to receive notifications from notifier NFs of a communication network, the method comprising:
   generating a first access token indicating that a notifier NF is authorized to send notifications to the receiver NF in accordance with a subscription;
   sending, to a first NF of the communication network, a first message related to a subscription for receiving notifications from the notifier NF, wherein the first message includes the first access token; and
   receiving a notification from the notifier NF in accordance with the subscription, wherein the notification includes or is received in association with a further access token; and
   based on the further access token, verifying that the notifier NF is authorized to send the notification.
A2. The method of embodiment A1, wherein the first NF is the notifier NF and the first message is a subscription request for notifications from the notifier NF.
A3. The method of embodiment A1, wherein the first NF is a subscriber NF different from the receiver NF, and the first message is one of the following:
   a subscription request for notifications from the notifier NF, or
   a service request indicating that the subscriber NF should subscribe to notifications on behalf of the receiver NF.
A4. The method of embodiments A1, further comprising registering a NF profile of the receiver NF with a network repository function (NRF) of the communication network, wherein the registered NF profile includes the following:
   a default callback uniform resource identifier (URI), at which the receiver NF can receive notifications; and
   one of the following:
      a token endpoint, from which access tokens for sending notifications to the receiver NF can be obtained; or
      a default access token for sending notifications to the receiver NF;
A5. The method of embodiment A4, wherein:
   the method further comprises receiving a token request from the notifier NF via the token endpoint;
   the first access token is generated in response to the token request;
   the first message is a token response; and
   the notification is received at the default callback URI.
A6. The method of any of embodiments A1-A5, wherein the first access token includes one or more of the following information:
   an indication of whether the subscription is implicit or explicit;
   an identifier of the subscription;
   a validity duration associated with the subscription;
   a notification type associated with the subscription;
   a callback uniform resource identifier (URI) at which the receiver NF can receive the notifications;
   a callback URI schema, from which callback URIs for notifications to the receiver NF can be generated;
   one or more of the following associated with the receiver NF: NF type, binding indication, NF set, NF service set, one or more NF instances, and one or more NF service instances; and
   one or more of the following associated with the notifier NF: NF type, NF set, and one or more NF instances.
A7. The method of any of embodiments A1-A6, wherein the first message includes one or more of the following information:
   an indication of whether the subscription is implicit or explicit;
   an identifier of the subscription;
   a validity duration associated with the subscription;
   a notification type associated with the subscription;
   a callback uniform resource identifier (URI) at which the receiver NF can receive the notifications;
   a callback URI schema, from which callback URIs for notifications to the receiver NF can be generated;
   one or more of the following associated with the receiver NF: NF type, binding indication, NF set, NF service set, one or more NF instances, and one or more NF service instances;
   one or more of the following associated with the notifier NF: NF type, NF set, and one or more NF instances; and
   a URI from which a public key of the receiver NF can be obtained.
A8. The method of any of embodiments A1-A7, wherein verifying that the notifier NF is authorized to send the notification comprises:
   storing the generated first access token; and
   comparing the stored first access token to the received further access token,
   wherein a match or correspondence between the first access token and the further access token indicates that the notifier NF is authorized to send the notification.
A9. The method of any of embodiments A1-A7, wherein:
   generating the first access token comprises applying integrity protection to the first access token using a private key of the receiver NF; and
   verifying that the notifier NF is authorized to send the notification comprises verifying corresponding integrity protection included in or with the further access token based on a public key of the receiver NF.
A10. The method of embodiment A9, wherein one or more of the following applies:
   the integrity protection applied to the first access token comprises one of the following generated using the private key: digital signature, message authentication code, and cryptographic hash; and
   the public key and the private key are locally generated by the receiver NF.
A11. The method of any of embodiments A9-A10, wherein verifying the corresponding integrity protection included in or with the further access token comprises determining that the further access token was generated by the receiver NF, has not been modified by another entity, and has an unexpired validity duration.
A12. The method of any of embodiments A1-A11, wherein the first message includes a second access token indicating that the receiver NF is authorized to subscribe to the notifications from the notifier NF.
A13. The method of any of embodiments A1-A12, wherein one or more of the following applies: the receiver NF is an access and mobility management function (AMF), and the notifier NF is a unified data management (UDM) function.
B1. A method performed by a notifier network function (NF) arranged to send notifications to receiver NFs in a communication network, the method comprising:
   receiving, from a first NF of the communication network, a first message related to a subscription for a receiver NF to receive notifications from the notifier NF, wherein the first message includes a first access token indicating that the notifier NF is authorized to send notifications to the receiver NF in accordance with the subscription; and
   sending, to the receiver NF, a notification in accordance with the subscription, wherein the notification includes or is sent in association with the first access token.
B2. The method of embodiment B1, wherein:
   the first message is a subscription request for notifications from the notifier NF; and
   the first NF is the receiver NF or a subscriber NF authorized to subscribe to notifications on behalf of the receiver NF.
B3. The method of embodiment B2, wherein the subscription request is for the receiver NF to receive notifications from the notifier NF.
B4. The method of embodiment B3, wherein:
   the subscription request is for the receiver NF and the subscriber NF to receive notifications from the notifier NF; and
   the first message includes a further first access token indicating that the notifier NF is authorized to send notifications to the subscriber NF in accordance with the subscription.
B5. The method of embodiment B1, wherein the first NF is the notifier NF and the first message is a token response.
B6. The method of embodiment B5, further comprising:
   obtaining the following from a network repository function (NRF) of the communication network:
      a default callback uniform resource identifier (URI), at which the receiver NF can receive notifications; and
      a token endpoint, from which access tokens for sending notifications to the receiver NF can be obtained,
   wherein the token response is responsive to the token request and the notification is sent to the default callback URI.
B7. The method of any of embodiments B1-B6, wherein the first access token includes one or more of the following information:
   an indication of whether the subscription is implicit or explicit;
   an identifier of the subscription;
   a validity duration associated with the subscription;
   a notification type associated with the subscription;
   a callback uniform resource identifier (URI) at which the receiver NF can receive the notifications;
   a callback URI schema, from which callback URIs for notifications to the receiver NF can be generated;
   one or more of the following associated with the receiver NF: NF type, binding indication, NF set, NF service set, one or more NF instances, and one or more NF service instances; and
   one or more of the following associated with the notifier NF: NF type, NF set, and one or more NF instances.
B8. The method of any of embodiments B1-B7, wherein the first message includes one or more of the following information:
   an indication of whether the subscription is implicit or explicit;
   an identifier of the subscription;
   a validity duration associated with the subscription;
   a notification type associated with the subscription;
   a callback uniform resource identifier (URI) at which the receiver NF can receive the notifications;
   a callback URI schema, from which callback URIs for notifications to the receiver NF can be generated;
   one or more of the following associated with the receiver NF: NF type, binding indication, NF set, NF service set, one or more NF instances, and one or more NF service instances;
   one or more of the following associated with the notifier NF: NF type, NF set, and one or more NF instances; and
   a URI from which a public key of the receiver NF can be obtained.
B9. The method of any of embodiments B1-B8, wherein:
   the first access token is integrity protected based on a private key of the receiver NF; and
   the method further comprises verifying the integrity protection of the first access token based on a public key of the receiver NF.
B10. The method of embodiment B9, wherein the integrity protection of the first access token comprises one of the following generated based on the private key of the receiver NF: digital signature, message authentication code, and cryptographic hash.
B11. The method of any of embodiments B9-B10, wherein verifying the integrity protection of the first access token comprises determining that the first access token was generated by the receiver NF, has not been modified by another entity, and has an unexpired validity duration.
B12. The method of any of embodiments B1-B11, wherein the first message includes a second access token indicating that the receiver NF is authorized to subscribe to the notifications from the notifier NF.
B13. The method of any of embodiments B1-B12, wherein one or more of the following applies: the receiver NF is an access and mobility management function (AMF), and the notifier NF is a unified data management (UDM) function.
C1. A method performed by a subscriber network function (NF) arranged to subscribe to notifications from a notifier NF of a communication network on behalf of a receiver NF of the communication network, the method comprising:
   receiving, from the receiver NF, a first message related to a subscription for receiving notifications from the notifier NF, wherein the first message includes a first access token indicating that the notifier NF is authorized to send notifications to the receiver NF in accordance with the subscription; and
   sending, to the notifier NF, a subscription request in accordance with the first message, wherein the subscription request includes the first access token.
C2. The method of embodiment C1, wherein the first message is a subscription request for notifications from the notifier NF.
C3. The method of embodiment C1, wherein the first message is a service request indicating that the subscriber NF should subscribe to notifications from the notifier NF on behalf of the receiver NF.
C4. The method of any of embodiments C1-C3, wherein:
   the method further comprises generating a further first access token indicating that the notifier NF is authorized to send notifications to the subscriber NF in accordance with the subscription of the receiver NF; and
   the subscription request to the notifier NF includes the further first access token.
C5. The method of embodiment C4, further comprising:
   receiving a notification from the notifier NF in accordance with the subscription, wherein the notification includes or is received in association with a further access token; and
   based on the further access token, verifying that the notifier NF is authorized to send the notification.
C6. The method of embodiment C5, wherein verifying that the notifier NF is authorized to send the notification comprises:
   storing the generated further first access token; and
   comparing the stored further first access token to the received further access token,
   wherein a match or correspondence between the further first access token and the further access token indicates that the notifier NF is authorized to send the notification.
C7. The method of embodiments C5, wherein:
   generating the further first access token comprises applying integrity protection to the further first access token using a private key of the subscriber NF; and
   verifying that the notifier NF is authorized to send the notification comprises verifying corresponding integrity protection included in or with the further access token based on a public key of the subscriber NF.
C8. The method of embodiment C7, wherein one or more of the following applies:
   the integrity protection applied to the further first access token comprises one of the following generated using the private key of the subscriber NF: digital signature, message authentication code, and cryptographic hash; and
   the public key and the private key are locally generated by the subscriber NF.
C9. The method of any of embodiments C7-C8, wherein verifying the corresponding integrity protection included in or with the further access token comprises determining that the further access token was generated by the subscriber NF, has not been modified by another entity, and has an unexpired validity duration.
C10. The method of any of embodiments C1-C9, wherein the first access token includes one or more of the following information:
   an indication of whether the subscription is implicit or explicit;
   an identifier of the subscription;
   a validity duration associated with the subscription;
   a notification type associated with the subscription;
   a callback uniform resource identifier (URI) at which the receiver NF can receive the notifications;
   a callback URI schema, from which callback URIs for notifications to the receiver NF can be generated;
   one or more of the following associated with the receiver NF: NF type, binding indication, NF set, NF service set, one or more NF instances, and one or more NF service instances; and
   one or more of the following associated with the notifier NF: NF type, NF set, and one or more NF instances.
C11. The method of any of embodiments C1-C10, wherein the first message includes one or more of the following information:
   an indication of whether the subscription is implicit or explicit;
   an identifier of the subscription;
   a validity duration associated with the subscription;
   a notification type associated with the subscription;
   a callback uniform resource identifier (URI) at which the receiver NF can receive the notifications;
   a callback URI schema, from which callback URIs for notifications to the receiver NF can be generated;
   one or more of the following associated with the receiver NF: NF type, binding indication, NF set, NF service set, one or more NF instances, and one or more NF service instances;
   one or more of the following associated with the notifier NF: NF type, NF set, and one or more NF instances; and
   a URI from which a public key of the receiver NF can be obtained.
C11a. The method of embodiment C11, wherein the subscription request includes at least a portion of the information included in the first message.
C12. The method of any of embodiments C1-C11a, wherein the first message and the subscription request include a second access token indicating that the receiver NF is authorized to subscribe to the notifications from the notifier NF.
C13. The method of any of embodiments C1-C12, wherein one or more of the following applies: the receiver NF is a first access and mobility management function (AMF), the notifier NF is a unified data management (UDM) function, and the subscriber NF is a second AMF different from the first AMF.
D1. A method performed by a network repository function (NRF) of a communication network, the method comprising:
   registering a network function (NF) profile of a receiver NF of the communication network, wherein the registered NF profile includes the following:
      a default callback uniform resource identifier (URI), at which the receiver NF can receive notifications; and
      one of the following:
         a token endpoint, from which access tokens for sending notifications to the receiver NF can be obtained; or
         a default access token for sending notifications to the receiver NF;
   receiving, from a notifier NF of the communication network, a discovery request to identify NFs of the communication network that are subscribed to notifications provided by the notifier NF;
   identifying the receiver NF based on the registered NF profile and the discovery request; and
   sending to the notifier NF a discovery response that includes the default callback URI and the token endpoint.
D2. The method of embodiment D1, wherein one or more of the following applies: the receiver NF is an access and mobility management function (AMF), and the notifier NF is a unified data management (UDM) function.
E1. A receiver network function (NF) arranged to receive notifications from notifier NFs of a communication network, the receiver NF comprising:
   communication interface circuitry configured to communicate with the notifier NFs and with a network repository function (NRF) of the communication network; and
   processing circuitry operably coupled to the communication interface circuitry, whereby the processing circuitry and the communication interface circuitry are configured to perform operations corresponding to any of the methods of embodiments A1-A13.
E2. A receiver network function (NF) arranged to receive notifications from notifier NFs of a communication network, the receiver NF being further arranged to perform operations corresponding to any of the methods of embodiments A1-A13.
E3. A non-transitory, computer-readable medium storing computer-executable instructions that, when executed by processing circuitry associated with receiver network function (NF) arranged to receive notifications from notifier NFs of a communication network, configure the receiver NF to perform operations corresponding to any of the methods of embodiments A1-A13.
E4. A computer program product comprising computer-executable instructions that, when executed by processing circuitry associated with receiver network function (NF) arranged to receive notifications from notifier NFs of a communication network, configure the receiver NF to perform operations corresponding to any of the methods of embodiments A1-A13.
F1. A notifier network function (NF) arranged to send notifications to receiver NFs in a communication network, the notifier NF comprising:
   communication interface circuitry configured to communicate with the receiver NFs and with a network repository function (NRF) of the communication network; and
   processing circuitry operably coupled to the communication interface circuitry, whereby the processing circuitry and the communication interface circuitry are configured to perform operations corresponding to any of the methods of embodiments B1-B13.
F2. A notifier network function (NF) arranged to send notifications to receiver NFs in a communication network, the notifier NF being further arranged to perform operations corresponding to any of the methods of embodiments B1-B13.
F3 A non-transitory, computer-readable medium storing computer-executable instructions that, when executed by processing circuitry associated with a notifier network function (NF) arranged to send notifications to receiver NFs in a communication network, configure the notifier NF to perform operations corresponding to any of the methods of embodiments B1-B13.
F4. A computer program product comprising computer-executable instructions that, when executed by processing circuitry associated with a notifier network function (NF) arranged to send notifications to receiver NFs in a communication network, configure the notifier NF to perform operations corresponding to any of the methods of embodiments B1-B13.
G1. A subscriber network function (NF) arranged to subscribe to notifications from a notifier NF of a communication network on behalf of a receiver NF of the communication network, the subscriber NF comprising:
   communication interface circuitry configured to communicate with the notifier NF and with the receiver NF; and
   processing circuitry operably coupled to the communication interface circuitry, whereby the processing circuitry and the communication interface circuitry are configured to perform operations corresponding to any of the methods of embodiments C1-C13.
G2. A subscriber network function (NF) arranged to subscribe to notifications from a notifier NF of a communication network on behalf of a receiver NF of the communication network, the subscriber NF being further arranged to perform operations corresponding to any of the methods of embodiments C1-C13.
G3. A non-transitory, computer-readable medium storing computer-executable instructions that, when executed by processing circuitry associated with a notifier network function (NF) arranged to send notifications to receiver NFs in a communication network, configure the notifier NF to perform operations corresponding to any of the methods of embodiments C1-C13.
G4. A computer program product comprising computer-executable instructions that, when executed by processing circuitry associated with a notifier network function (NF) arranged to send notifications to receiver NFs in a communication network, configure the notifier NF to perform operations corresponding to any of the methods of embodiments C1-C13.
H1. A network repository function (NRF) of a communication network, the NRF comprising:
   communication interface circuitry configured to communicate with receiver network functions (NFs) and notifier NFs of the communication network; and
   processing circuitry operably coupled to the communication interface circuitry, whereby the processing circuitry and the communication interface circuitry are configured to perform operations corresponding to any of the methods of embodiments D1-D2
H2. A network repository function (NRF) of a communication network, the NRF being arranged to perform operations corresponding to any of the methods of embodiments D1-D2.
H3. A non-transitory, computer-readable medium storing computer-executable instructions that, when executed by processing circuitry associated with a network repository function (NRF) of a communication network, configure the NRF to perform operations corresponding to any of the methods of embodiments D1-D2.
H4. A computer program product comprising computer-executable instructions that, when executed by processing circuitry associated with a network repository function (NRF) of a communication network, configure the NRF to perform operations corresponding to any of the methods of embodiments D1-D2.

1.-66. (canceled)

67. A method performed by a receiver network function (NF) arranged to receive notifications from notifier NFs of a communication network, the method comprising:
generating a first access token indicating that a notifier NF is authorized to send notifications to the receiver NF in accordance with a subscription;
sending, to a first NF of the communication network, a first message related to a subscription for receiving notifications from the notifier NF, wherein the first message includes the first access token; and
receiving a notification from the notifier NF in accordance with the subscription, wherein the notification includes or is received in association with a further access token; and
based on the further access token, verifying that the notifier NF is authorized to send the notification.

68. The method of claim 67, wherein the first NF is the notifier NF and the first message is a subscription request for notifications from the notifier NF.

69. The method of claim 67, wherein the first NF is a subscriber NF different from the receiver NF, and the first message is one of the following:
a subscription request for notifications from the notifier NF, or
a service request indicating that the subscriber NF should subscribe to notifications on behalf of the receiver NF.

70. The method of claim 67, further comprising registering a NF profile of the receiver NF with a network repository function (NRF) of the communication network, wherein the registered NF profile includes the following:
a default callback uniform resource identifier (URI) at which the receiver NF can receive notifications; and
one of the following:
a token endpoint, from which access tokens for sending notifications to the receiver NF can be obtained; or
a default access token for sending notifications to the receiver NF.

71. The method of claim 70, further comprising receiving a token request from the notifier NF via the token endpoint, wherein:
the first access token is generated in response to the token request;
the first message is a token response; and
the notification is received at the default callback URI.

72. The method of claim 67, wherein the first access token includes one or more of the following information:
an indication of whether the subscription is implicit or explicit;
an identifier of the subscription;
a validity duration associated with the subscription;
a notification type associated with the subscription;
a callback uniform resource identifier (URI) at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances; and
one or more of the following associated with the notifier NF: NF type, NF set, and one or more NF instances.

73. The method of claim 67, wherein the first message includes one or more of the following information:
an indication of whether the subscription is implicit or explicit;
an identifier of the subscription;
a validity duration associated with the subscription;
a notification type associated with the subscription;
a callback uniform resource identifier (URI) at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances;
one or more of the following associated with the notifier NF: NF type, NF set, and one or more NF instances; and
a URI from which a public key of the receiver NF can be obtained.

74. The method of claim 67, wherein verifying that the notifier NF is authorized to send the notification comprises:
storing the generated first access token; and
comparing the stored first access token to the received further access token,
wherein a match or correspondence between the first access token and the further access token indicates that the notifier NF is authorized to send the notification.

75. The method of claim 67, wherein:
generating the first access token comprises applying integrity protection to the first access token using a private key of the receiver NF; and
verifying that the notifier NF is authorized to send the notification comprises verifying corresponding integrity protection included in or with the further access token, based on a public key of the receiver NF.

76. A method performed by a notifier network function (NF) arranged to send notifications to receiver NFs in a communication network, the method comprising:
receiving, from a first NF of the communication network, a first message related to a subscription for a receiver NF to receive notifications from the notifier NF, wherein the first message includes a first access token indicating that the notifier NF is authorized to send notifications to the receiver NF in accordance with the subscription; and
sending, to the receiver NF, a notification in accordance with the subscription, wherein the notification includes or is sent in association with the first access token.

77. The method of claim 76, wherein:
the first message is a subscription request for notifications from the notifier NF; and
the first NF is the receiver NF or a subscriber NF authorized to subscribe to notifications on behalf of the receiver NF.

78. The method of claim 77, wherein the subscription request is for the receiver NF to receive notifications from the notifier NF.

79. The method of claim 78, wherein:
the subscription request is for the receiver NF and the subscriber NF to receive notifications from the notifier NF; and
the first message includes a further first access token indicating that the notifier NF is authorized to send notifications to the subscriber NF in accordance with the subscription.

80. The method of claim 76, wherein the first NF is the notifier NF and the first message is a token response.

81. The method of claim 80, further comprising:
obtaining the following from a network repository function (NRF) of the communication network:
a default callback uniform resource identifier (URI) at which the receiver NF can receive notifications; and
a token endpoint, from which access tokens for sending notifications to the receiver NF can be obtained; and
sending a token request to the receiver NF via the token endpoint,
wherein the token response is responsive to the token request and the notification is sent to the default callback URI.

82. The method of claim 76, wherein the first access token includes one or more of the following information:
an indication of whether the subscription is implicit or explicit;
an identifier of the subscription;
a validity duration associated with the subscription;
a notification type associated with the subscription;
a callback uniform resource identifier (URI) at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances; and
one or more of the following associated with the notifier NF: NF type, NF set, and one or more NF instances.

83. The method of claim 76, wherein the first message includes one or more of the following information:
an indication of whether the subscription is implicit or explicit;
an identifier of the subscription;
a validity duration associated with the subscription;
a notification type associated with the subscription;
a callback uniform resource identifier (URI) at which the receiver NF can receive the notifications;
a callback URI schema, from which callback URIs for notifications to the receiver NF can be generated;
one or more of the following associated with the receiver NF: NF type, binding indication, NF set, NF service set, one or more NF instances, and one or more NF service instances;
one or more of the following associated with the notifier NF: NF type, NF set, and one or more NF instances; and
a URI from which a public key of the receiver NF can be obtained.

84. The method of claim 76, wherein:
the first access token is integrity protected based on a private key of the receiver NF; and
the method further comprises verifying the integrity protection of the first access token based on a public key of the receiver NF.

85. Network equipment configured to implement a receiver network function (NF) arranged to receive notifications from notifier NFs of a communication network, the network equipment comprising:
communication interface circuitry configured to communicate with the notifier NFs and with a network repository function (NRF) of the communication network; and
processing circuitry operably coupled to the communication interface circuitry, wherein the processing circuitry and the communication interface circuitry are configured to:
generate a first access token indicating that a notifier NF is authorized to send notifications to the receiver NF in accordance with a subscription;
send, to a first NF of the communication network, a first message related to a subscription for receiving notifications from the notifier NF, wherein the first message includes the first access token; and
receive a notification from the notifier NF in accordance with the subscription, wherein the notification includes or is received in association with a further access token; and
based on the further access token, verify that the notifier NF is authorized to send the notification.

86. Network equipment configured to implement a notifier network function (NF) of a communication network, the network equipment comprising communication interface circuitry and processing circuitry that are operably coupled and are configured to perform the method of claim 76.
